(19) United States
(12) Patent Application Publication
(10) Pub. No.: US 2002/0103716 A1
(43) Pub. Date: Aug. 1, 2002

(54) System and method of selling and shipping fully upholstered furniture

(76) Inventors: Blaine L. Wieland, Fort Wayne, IN (US); Blair Wieland, Leo, IN (US)

Correspondence Address: ANTHONY NIEWYK, BAKER & DANIELS, Suite 800, 111 East Wayne Street, Fort Wayne, IN, 46802, US

(21) Appl. No.: 09/774,312

(22) Filed: Jan. 31, 2001

(51) Int. Cl. G06F 17/60

(52) U.S. Cl. 705/26

(57) ABSTRACT

A system and method for buying and selling fully upholstered furniture for direct delivery via a parcel delivery service such as, e.g., FEDERAL EXPRESS GROUND and UNITED PARCEL SERVICE. A computer system may be utilized having a remote computer to contact a server via a computer network such as the Internet. The server stores information relating to availability of furniture types and upholstery cover styles and communicates order information to an order receipt and fulfillment center for transmission via direct parcel delivery to the consumer. The furniture of the current invention comprises fully upholstered full-scale furniture (e.g., chairs, loveseats, sofas, sofa beds, and ottomans) including a frame having a plurality of interlocking planar frame members which are secured together by fasteners received in push in connector elements. Upholstery coverings are attached to the frame and secured to one another by, e.g., hook and loop fasteners or zippers and are separately returnable. Foam elements are received within a second plurality of upholstery covers which have large openings for receiving the foam elements to provide cushions for the article of furniture. The frame members, upholstery covers, and foam elements are packaged in first, second, and third containers, respectively, which are each of sufficiently small size and weight to be shipped for direct parcel delivery to the consumer.

### BACKGROUND OF THE INVENTION

1. Field of the Invention

The invention relates to methods of selling a complete line of low priced, fully upholstered furniture (e.g., chairs, loveseats, sofas, sofa beds, and ottomans). More particularly, the invention relates to a method of selling a complete line of low priced, fully upholstered furniture via, e.g., a computer network, with direct consumer delivery of the furniture via a parcel delivery service.

2. Description of the Related Art

Typical method of purchasing upholstered furniture

Typically, the way that a consumer buys fully upholstered furniture such as chairs, loveseats and sofas, is to visit a retail furniture showroom, make a selection and receive delivery via the delivery service of that retailer. The route this product has taken to get from the manufacturer to the customer home is not very efficient. It involves shipment from the manufacturer to the retailer (where it is carried as inventory) and then shipment again from the retailer to the customer's home.

If a consumer makes a custom fabric selection for an upholstered item, things get even more complicated. If the retailer doesn't carry a particular item in the selected fabric, the retailer has to wait for the products to arrive from the manufacturer before they can be delivered. The net result of all this is extra costs and delays to the consumer. The customer must pay the costs for a middleman (i.e., the furniture retailers), and if he were to order a custom fabric choice, must allow for lengthy delivery times.

New method of purchasing upholstered furniture

As the Internet has developed, furniture retailers and manufacturers have developed web sites to sell upholstered furniture products. Customers can browse their offerings and purchase items via electronic credit card transactions. There are two very significant problems with this new method when a company is trying to provide low cost products to their consumers.

Number one, most chairs, loveseats, sofas and sofa beds can't be shipped by standard parcel delivery services such as, e.g., UNITED PARCEL SERVICE and FEDEX GROUND. They are outside the limits of their size and/or weight requirements. That means that other, more costly shipping methods must be used, methods like common carriers (e.g., trucking lines), networks of local in-home delivery providers, or special services divisions of the parcel services. All of these methods raise the costs of shipping to the customer relative to shipping via non-specialized parcel delivery.

Number two, customers cannot see and touch the furniture before they buy it. According to Furniture Today, one of the industries top trade magazines, the number one reason for a customer to return an upholstered furniture item is dissatisfaction with the fabric. Therefore, an online seller of upholstered products runs the risk of a high return rate. Returns must be shipped back to the seller using the same inefficient, costly delivery methods as when it was sent out. As stated above, this is due to the size and weight problem and inability to use the conventional parcel delivery services of companies like UNITED PARCEL SERVICE and FEDEX GROUND. This problem adds a significant cost to the web site operator, which costs are passed on to the customers if the business is to stay viable.

The Potential

As of February 1999, there were an estimated 90 million Internet users in the United States representing 33% of the population with growth rates estimated from 20% to 50% or more annually. The Internet has emerged as a global platform that allows millions of people to share information and conduct business. International Data Corporation estimates that the number of Internet users worldwide who make purchases over the Internet will grow from approximately thirty-one million users in 1998 to more than one hundred eighty-three million in 2003. The Internet therefore presents a significant opportunity for promotion and sale of items both tangible and intangible provided that an appropriate system is available for selling, shipping and returning these items.

What is Needed

What is needed in the art is a system and method for selling and shipping fully upholstered furniture for direct parcel delivery to a consumer.

What is further needed in the art is a system and method whereby the Internet can be utilized as a medium through which a line of fully upholstered furniture, (e.g., chairs, loveseats, sofas, sofa beds and ottomans) may be purchased for direct consumer delivery via a parcel delivery service.

What is further yet needed in the art is a system and method that reduces the risk and cost of returns by enabling fabric covers for upholstered furniture to be returned and replaced separately from the frame and cushion material of the item of furniture.

### SUMMARY OF THE INVENTION

The present invention provides a method for direct consumer ordering of fully upholstered custom furniture for direct parcel delivery, e.g., via UNITED PARCEL SERVICE or FEDERAL EXPRESS GROUND. According to the present invention, a consumer views a paper or electronic catalog of fully upholstered furniture styles and upholstery cover choices and subsequently selects a furniture style and upholstery cover design for purchase. The articles of furniture in accordance with the present invention can be packaged in bundles having a size and weight less than the size and weight restrictions imposed by standard parcel delivery services such as, e.g., UNITED PARCEL SERVICE or FEDERAL EXPRESS GROUND. The packaging technique of the current invention thereby allows direct delivery of the ordered article of furniture to the consumer, thus eliminating the “middle man” (i.e., the furniture retailer) and allowing for furniture sales to occur with the consumer placing an order from a remote location and receiving direct parcel delivery of the furniture item ordered.

The furniture of the current invention includes a frame having a plurality of planar frame members which are interconnected by interlocking protrusions and cut out portions as well as by threaded fasteners received in push in connector elements held in recesses of the frame members. A first plurality of upholstery covers cover the frame and are attached to one another by hook and loop fasteners. A second plurality of upholstery covers cover padding elements to form cushions for the article of furniture. For shipment, the article of furniture may be packaged so that the frame members, connector elements, and fasteners are packaged in one or more first containers, while the padding elements are packaged in one or more second containers, and the upholstery covers are packaged in a third container or together with the padding elements in the second container. Each container weighs less than seventy pounds and is within the size requirements of standard parcel delivery services such as, e.g. UNITED PARCEL SERVICE or FEDERAL EXPRESS GROUND. Standard UNITED PARCEL SERVICE delivery allows for a maximum package weight of 150 pounds, a maximum package length of 270 centimeters (108 inches), and a maximum package size of 330 centimeters (130 inches) in length and girth combined. Similarly, FEDERAL EXPRESS GROUND allows for a maximum package weight of 150 pounds and a maximum package size of 419 centimeters (165 inches). The furniture kit of the present invention, when assembled, provides an article of comfortable, fully upholstered furniture which can match a variety of decors. Furniture in accordance with the present invention includes, e.g., chairs, ottomans, couches, loveseats, and sofa beds.

Interchangeable, fitted decorative coverings are separately provided to cover the furniture and provide continued flexibility and variety in accommodating the consumer's decorating tastes. Provision of discrete upholstery covers advantageously allows for the efficient return and exchange thereof. The purchaser of an item of upholstered furniture in accordance with the present invention can assemble the furniture item and determine whether the upholstery cover is compatible with the consumer's existing decorum. Should the consumer wish to change the upholstery (color, pattern, etc.), he must simply remove the covers from the item of furniture and return only the covers for replacement. The packaging of the current invention may include return packaging for the upholstery covers to further facilitate exchange of upholstery covers. The packages containing the separate components of the furniture of the current invention are light-weight, compact, and maneuverable and therefore may also advantageously be efficiently stocked. The light weight, compact and maneuverable package size further allows the packages to meet the size and weight limitations of a direct parcel delivery service.

The invention, in one form thereof, comprises a method of selling fully upholstered furniture. The method comprises the steps of: receiving a consumer order for a desired furniture type and upholstery cover style; determining if the desired furniture type and upholstery cover is available; gathering all the furniture components necessary to complete the order; packaging all the furniture components into at least one shipping package that is within the size and weight limitations of a direct parcel delivery service; and shipping, via the direct parcel delivery service, the furniture components to the consumer.

The invention, in another form thereof, comprises a method of receiving consumer orders for fully upholstered furniture and delivering the orders to the consumers via direct parcel delivery. The method utilizes a computer system and comprises the steps of: providing an interface on a computer for entering a consumer order for a desired furniture type and upholstery cover style; determining if the desired furniture type and upholstery cover style is available; gathering all the furniture components necessary to complete the order; packing the furniture components into at least one shipping package that is within the size and weight limitations of a regular direct parcel delivery service; and shipping, via the direct parcel delivery service, the furniture components to the consumer.

The invention, in another form thereof, comprises a computer system for allowing consumers to order fully upholstered furniture for direct parcel delivery to the consumer. The computer system includes a server which stores information relating to the availability of furniture types and upholstery cover styles, and which is coupled to a communications network. A customer interface is operated by the server and includes a query system for allowing a user of the customer computer to submit an inquiry to the server relating to a desired furniture type and upholstery cover style. The customer interface further includes an ordering system for allowing a user of the customer computer to submit an order for a desired furniture type and upholstery cover style for direct parcel delivery to the user. The server includes a plurality of instructions for enabling the server to receive the inquiry from the customer computer, determine if the desired furniture and upholstery cover style is available, and provide an output including identifying information relating to the furniture components necessary to complete the order. The furniture components ordered by the computer system according to the invention are packaged into at least one shipping package that is within the size and weight limitations of a direct parcel delivery service.

An advantage of the present invention is the ability to provide a system and method which allows a consumer to conveniently select and purchase furniture from a paper or an electronic catalog while eliminating the lengthy period of time for delivery which was customary in systems of the prior art.

Another advantage of the present invention is the ability to provide a system and method for selling furniture for direct consumer delivery via standard parcel delivery services.

A further advantage of the present invention is the ability to accommodate various consumer decorating tastes by stocking a variety of interchangeable fitted upholstery covering fabrics for the furniture of the present invention. The upholstery covers can be custom selected by the consumer and can, furthermore, be sold separately so that redecorating can be performed without requiring the purchase of an entirely new piece of furniture. Additionally, individual pieces of the upholstery covering, if damaged or stained, for example, may be selectively ordered by the consumer and shipped to the consumer for replacement.

Yet another advantage of the present invention is the reduction in shipping costs and/or labor associated with the ease of transportation of the furniture kits of the current invention.

### BRIEF DESCRIPTION OF THE DRAWINGS

The above-mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of the interaction of the present invention;

FIG. 2 is a perspective view of the fitted fabric covering for one of the foam pieces of one embodiment of the present invention;

FIG. 3 is a view illustrating assembly of an upholstered piece to the frame of one embodiment of an article of furniture produced in accordance with the present invention;

FIG. 4 is a perspective view of a second embodiment of an upholstered article of furniture produced in accordance with the present invention;

FIG. 5 is a perspective view of a third embodiment of an upholstered article of furniture produced in accordance with the present invention;

FIG. 6 is a perspective view of a fourth embodiment of an upholstered article of furniture produced in accordance with the present invention;

FIG. 7 is an exploded view of the frame of a fifth embodiment of an article of furniture produced in accordance with the present invention;

FIG. 7A is a fragmentary view of a portion of the frame of FIG. 7, illustrating the attachment of individual adjacent frame members;

FIG. 8 is a perspective view of the assembled frame of FIG. 7;

FIG. 9 is a perspective view of the fifth embodiment of an article of furniture, illustrating the attachment of upholstery covers to the frame of FIG. 8;

FIG. 10 is a perspective of the fifth embodiment of an article of furniture, illustrating the assembly of cushions therefor;

FIG. 11 is a perspective view of an assembled article of furniture in accordance with the fifth embodiment;

FIG. 12 is an exploded view illustrating a method of packaging the disassembled article of furniture of FIG. 11;

FIG. 13 is a perspective view of the frame of a sixth embodiment of an article of furniture produced in accordance with the present invention;

FIGS. 14 and 15 are exploded views thereof;

FIG. 16 is a perspective view of the frame of the sixth embodiment positioned to form a bed; and

FIGS. 17-20 are perspective views of a sofabed cushion in accordance with the present invention.

Corresponding reference characters indicate corresponding parts throughout the several views. Although the drawings represent embodiments of the invention, the drawings are not necessarily to scale and certain features may be exaggerated to better illustrate and explain the invention. The exemplifications set out herein illustrate embodiments of the invention, in alternative forms, and such exemplifications are not to be construed as limiting the scope of the invention in any manner.

### DETAILED DESCRIPTION

The embodiments disclosed below are not intended to be exhaustive or limit the invention to the precise form disclosed in the following detailed description. Rather, the embodiments are chosen and described so that others skilled in the art may utilize their teachings.

The detailed descriptions which follow are presented in part in terms of algorithms and symbolic representations of operations on databits within a computer memory representing alphanumeric characters or other information. These descriptions and representations are the means used by those skilled in the art of data processing to most effectively convey the substance of their work to others skilled in the art.

An algorithm is here, and generally, conceived to be a self-consistent sequence of steps leading to a desired result. These steps are those requiring physical manipulation of physical quantities. Usually, though not necessarily, these quantities take the form of electrical or magnetic signals capable of being stored, transferred, combined, compared, and otherwise manipulated. It proves convenient at times, principally for reasons of common usage to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization to the information stored in memory. More than mere abstraction, the data structures are specific electrical or magnetic structural elements in memory which simultaneously accurately represent complex data and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention, the operations are machine operations. Useful machines for performing the operations of the present invention include general purpose digital computers or other similar devices. In all cases the distinction between the method operations in operating a computer and the method of computation itself should be recognized. The present invention relates, in at least one case, to a method and apparatus for operating a computer and processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be utilized with programs written in accordance with the teachings herein, or it may prove more convenient to construct a more specialized apparatus to perform the required method steps. The required structure for a variety of these machines will appear from the description below.

The present invention deals with “object-oriented” software, and particularly with an “object-oriented” operating system. The “object-oriented” software is organized into “objects,” each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The term “Browser” refers to a program which is not necessarily apparent to the user, but which is responsible for transmitting messages between the personal computer graphic interface and the network server and for displaying and interacting with the network user. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

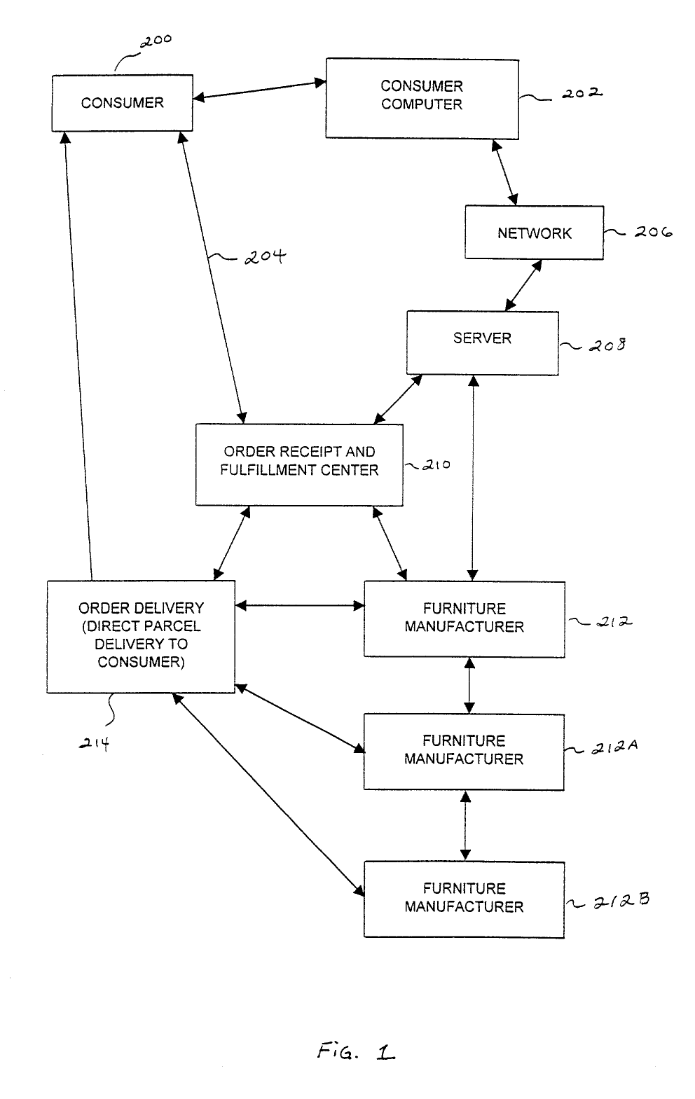

FIG. 1 shows, in diagram form, the interaction of the present invention. Consumer 200 contacts order receipt and fulfillment center 210 to place a furniture order and pay for same. Order receipt and fulfillment center 210 then contacts order delivery 214 for delivery of the furniture order directly to consumer 200. As illustrated in FIG. 1, consumer 200 can contact order receipt and fulfillment center 210 via consumer computer 202, or communication line 204. Communication line 204 may consist of any of the well-known means of communicating information such as, e.g., voice transmissions, or facsimile transmissions. In one exemplary embodiment, order receipt and fulfillment center 210 comprises a call center for receiving furniture orders via telephone and/or facsimile. Consumer 200 may also contact order receipt and fulfillment center 210 via consumer computer 202. In this configuration of the current invention, consumer computer 202 communicates via network 206 to server 208. Network 206 may be any of the well-known information networks such as, e.g., a LAN, WAN, or the Internet. Consumer computer 202 may be replaced by any known means for communicating to a network such as, e.g., the Internet. Such known means for communicating with the Internet include, e.g., wireless telephone and various other portable electronic devices.

Server 208 communicates with order receipt and fulfillment center 210 and maintains an inventory of furniture types and upholstery cover styles and their availability. This information can be accessed by consumer 200 via consumer computer 202, and network 206. Consumer computer 202 may include a browser interface that allows consumer 200 to navigate the information contained in server 208. Based upon the information contained in server 208, consumer 200 can choose a furniture type and upholstery cover style for delivery.

Order receipt and fulfillment center 210 may receive communication from server 208 that an order has been placed by consumer 200. Order receipt and fulfillment center 210 may package the furniture order (as will be more fully described hereinbelow) for pickup and delivery by order delivery 214. In one alternative embodiment, server 208 directly communicates order information to furniture manufacturer 212.

Order delivery 214 comprises a relatively low cost and generally available standard delivery service. Order delivery 214 may be a standard direct parcel delivery service such as, e.g., FEDERAL EXPRESS GROUND or UNITED PARCEL SERVICE. Order delivery 214 delivers the ordered furniture directly to consumer 200. A similar process will take place when consumer 200 directly contacts order receipt and fulfillment center 210. If consumer 200 directly contacts order receipt and fulfillment center 210 (via communication line 204) to place an order, server 208 will require modification to indicate that the ordered item has been removed from the available stock. In cases where the furniture order is received via server 208, the required inventory update may be performed automatically. Communication line 204 and/or consumer computer 210 may be automated as objects that receive orders and transmit the orders to order receipt and fulfillment center 210, or may be operated by human operators.

As illustrated in FIG. 1, furniture manufacturer 212 manufactures and provides furniture components to order delivery 214. In one alternative embodiment, furniture manufacturer 212 provides furniture components to order delivery 214 via order receipt and fulfillment center 210. In further alternative embodiments, multiple furniture manufacturing facilities may be utilized to manufacture the individual furniture components. For example, furniture manufacturer 212 may be utilized to manufacture a first furniture component, while furniture manufacturers 212A and 212B are utilized to manufacture second and third furniture components, respectively. Order receipt and fulfillment center 210 may be integrated with the manufacturing facility, or may be located remotely therefrom. As will be more fully described hereinbelow, the furniture construction of the current invention allows for easy storage of furniture components and therefore a stock of these components may be easily maintained at a location remote from the manufacturing facility for later shipping to the consumer. With this in mind, any or all of the furniture components may be housed at various locations including, e.g, order delivery 214, order receipt and fulfillment center 210, furniture manufacturer 212, furniture manufacturer 212A, and furniture manufacturer 212B.

The articles of furniture utilized with the teachings of the current invention are disclosed in co-pending U.S. Patent Application Serial No. 60/185,581, filed Feb. 28, 2000, the disclosure and specification of which is herein explicitly incorporated by reference. U.S. Patent Application Serial No. 60/185,581 contains disclosure of the articles of fully upholstered furniture to be sold in accordance with the present invention. For the sake of brevity, the entire disclosure of this co-pending U.S. Patent Application will not be repeated here. However, for the sake of clarity, several articles of structure of furniture constructed within the teachings of the current invention will now be briefly described.

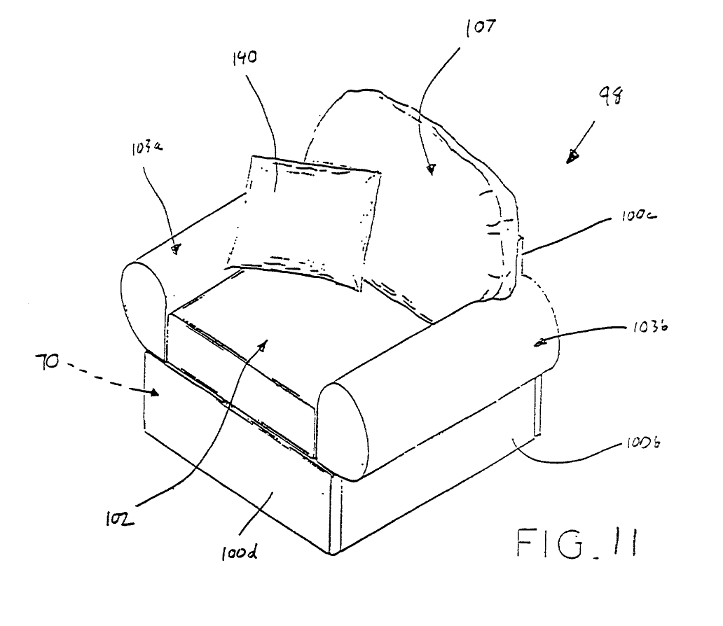

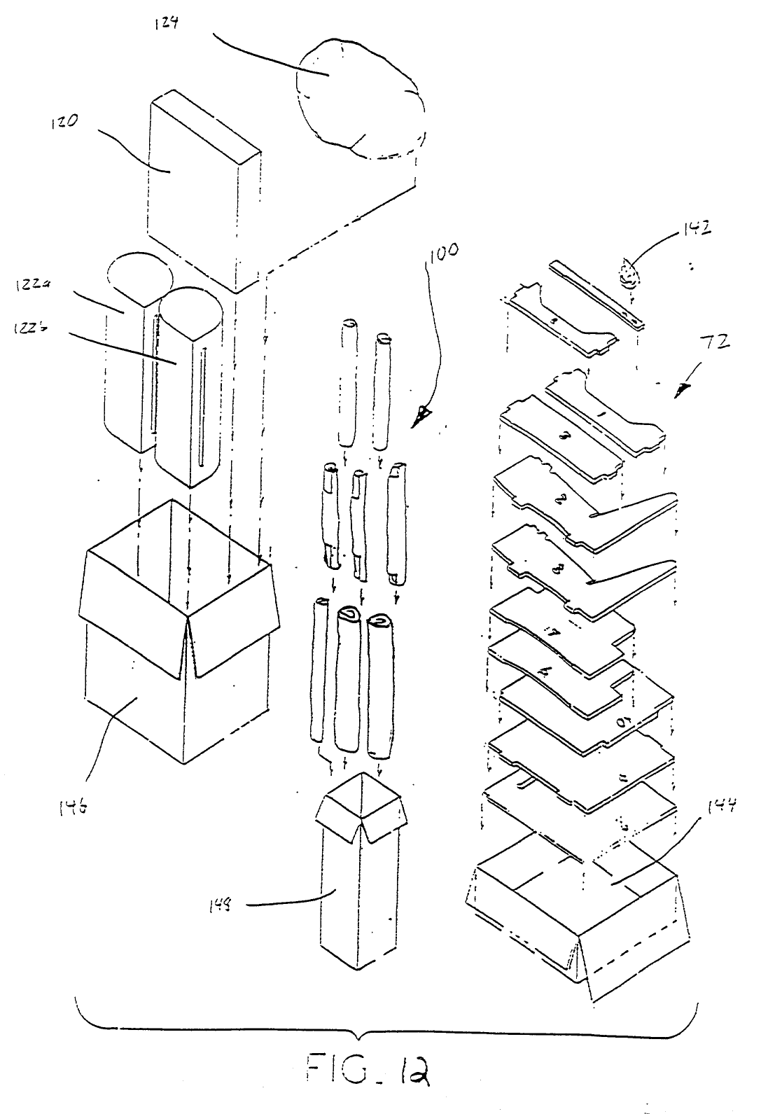

Generally, an article of furniture in accordance with the present invention is formed from frame members, push-in connector elements and fasteners, padding members, and upholstery covers. As illustrated in FIG. 12, frame members 72 as well as push-in connector elements 84 and fasteners 88 disposed within bag 142 are packaged in a first container 144. Seat padding 120, arm pads 122a, 122b, and seat back padding 124 are packaged in second container 146 and upholstery covers 100 are packaged in third container 148. These components will be utilized to form chair 98 (FIG. 11) as will be further described hereinbelow. Much of the detailed description that follows will make reference to chair 98. However, the system and method of the current invention is not limited to this embodiment and is equally applicable to various items of fully upholstered furniture including those disclosed in U.S. Patent Application Serial No. 60/185,581, explicitly incorporated by reference supra, as well as any of the items of furniture described hereinbelow.

The method of packaging the components of chair 98 as illustrated in FIG. 12 allows chair 98 to be packaged in three separate containers 144, 146, and 148, each of which weighs less than 70 pounds and is within the size constraints of UNITED PARCEL SERVICE and FEDERAL EXPRESS GROUND (i.e., length of 270 centimeters and combined length & girth of 330 centimeters, and 419 centimeters of combined length & girth, respectively), thus allowing containers 144, 146, and 148 to be shipped for direct home delivery by a standard commercial parcel carrier such as, e.g., UNITED PARCEL SERVICE and FEDERAL EXPRESS GROUND. Additionally, the shipment of chair 98 in separate containers uses packaging, such that separate sets of custom selected designs of upholstery covers 100 may be shipped with standard frame member 72 and standard pads 120, 122a, 122b, and 124. Additionally, upholstery covers 100 may be easily returned, without necessitating the return of all of the components of chair 98, if the upholstery cover is found to be unsuitable to the customer's liking or if it is later damaged.

The frame members of the current invention are formed from a suitable supporting material, such as pre-finished plywood. Alternative frame member materials include solid wooden board, laminated particle board, preformed plastic or metal pieces, varieties of fiber board or strandboard, structural cardboard, or honeycombed paperboard. Fasteners may or may not be required for interconnecting the frame members of the current invention. For example, frame assembly may instead consist of interconnecting frame members which include slots allowing their mutual engagement, or adhesives may be utilized to join the frame members.

FIG. 7 illustrates an embodiment of frame 70 including a plurality of individual frame members 72 which are assembled together to form frame 70. Frame members 72 are planar sheets or panels, and may be made of medium density fiber board (“MDF”). Frame members 72 may be cut from large sheets of MDF using widely available machinery such as computer-controlled cutting saws and routers, for example. As illustrated in FIG. 7, frame members 72 generally include base panel 72a, interior side panel 72b, 72c, arm panels 72d, 72e, front panel 72f, back panel 72g, seat back panel 72h, seat back support panel 72i, storage compartment lid panel 72j, and insert 72k. Storage compartment lid panel 72j includes handle cutout 74 and tongue 76, which is slidingly fitted within slot 78 of seat back panel 72h to provide a hinged connection therebetween.

Frame members 72 include projections 80 and cutout portions 82 which are insertable into one another to connect adjacent frame members 72. As illustrated in FIG. 7, cutout portions 82 may include slots 82a and apertures 82b. For securing adjacent frame members 72, recesses 83 are provided, which are adapted to receive push-in connector elements 84 (FIG. 7A). Additionally, apertures 86 are provided, which receive fasteners 88 cooperating with push-in connector elements 84 as illustrated in FIG. 7a. As illustrated in FIG. 7, each frame member 72 includes a number cutout 90, with frame members 72a-72k numbered 1-11, respectively, to define a sequentially numbered set of frame members 72 comprising frame 70. Numbering of frame members 72 advantageously eases assembly of frame 70 by allowing individual frame numbers 72 to be identified and referred to in a set of printed assembly instructions, for example.

As illustrated in FIG. 7, interior side panels 72b, 72c may include feet 92, covered by foot cap 94 which is pressed onto each foot 92. Foot caps 94 advantageously engage a floor surface to prevent frame 70 from sliding thereon and consequently scratching the floor surface. Foot caps 94 also serve as a protective “boot” to protect feet 92 from water or moisture and to protect feet 92 from contact with other objects which may cause feet 92 to dent, flake, or delaminate. FIG. 7A illustrates one method of attaching and securing adjacent frame members 72 to form frame 70. For example, projection 80 of front panel 72F is received within cutout portion 82 of arm panel 72E to interlockingly connect front panel 72f with arm panel 72e. To secure adjacent frame members 72, such as front panel 72f and arm panel 72e push-in connector elements 84, which may be formed of, e.g., any suitable plastic, are pushed into recesses 83 provided in front panel 72f. Fasteners 88 may then be threaded through apertures 86 in arm panel 72e, and subsequently received into push-in connector elements 84 within front panel 72f. Push-in connector elements 84 act as screw sets for fasteners 88, and also include oblong portions 96 disposed in recesses 83 to retain connector elements 84 therein and to prohibit separation of adjacent frame members 72.

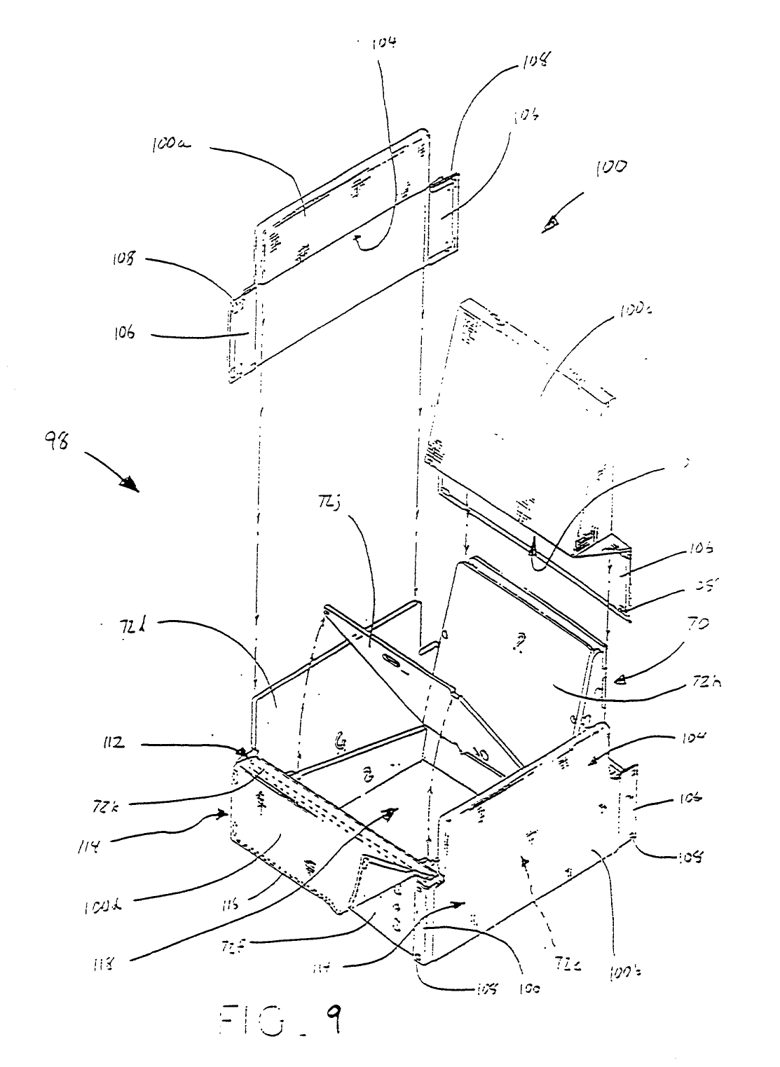

Frame 70 is illustrated in assembled form in FIG. 8, wherein frame 70 is utilized to form chair 98 (FIG. 11). Assembly of chair 98 is completed by attaching upholstery covers 100 and cushions 102 thereto as will be further described hereinbelow. It will be recognized by those skilled in the art that although the current description pertains to a chair, that many other articles of fully upholstered furniture, e.g., loveseats, sofas, sofa beds, or daybeds, may be constructed utilizing the teachings of the current invention.

Accommodating a variety of consumer tastes without requiring excessive warehouse or shelf space to house articles of furniture is an object of the present invention. Finished upholstery covers to fit individual padding elements and portions of the furniture frame are packaged in matching sets to outfit an entire article of furniture. With this in mind, a stock of kits can be conveniently warehoused to accommodate a variety of decorating tastes. The separately available fabric covers are installed by the consumer as illustrated, e.g., in FIG. 2. Fabric covering 44 is fitted over a foam arm cushion 42 to form an upholstered piece. Similarly, each foam piece is covered by a corresponding fabric cover. Furthermore, a fabric cover may be fashioned to cover more than one padded element. For example, a single decorative cover may be designed to accommodate three back cushions for a sofa. The fabric covers may be secured around the foam pieces by zippers, hook and loop fasteners, adhesives, or by merely folding excess material of the fabric under the foam piece itself or into slotted portion 48 (FIG. 3) of the foam piece. The entire padded portion may be covered by fabric or only the portion that would be visible upon final assembly of the furniture. The method of making available fabric covering sets separate from the remaining furniture assembly allows consumers to easily replace or return the fabric covers to obtain a new set for replacement and/or redecorating purposes. Once fabric is applied, each upholstered piece is applied to frame 36 as illustrated, e.g., in FIG. 3. As illustrated in FIG. 3, some upholstered pieces 46 are fitted over portions of frame 36 shaped to be slidedly received within slotted portions 48. Other upholstery pieces such as the seat portion, may be applied to the frame without such engagement.

Alternatively, the padded elements can be assembled to the frame without fabric covers. In this embodiment, the covers are later installed and are appropriately designed to cover a portion of the frame as well as the cushion. Tape with adhesive on both sides may be utilized in this embodiment to affix the covers to the frame and the cushions. One side of the tape may be permanently adhered to the frame with the decorative cover, which has been drawn over a cushion, detachably adhered to the other side of the tape. Further embodiments may utilize fabric covers designed to fit over some portions of the frame in lieu of padding. Further still, fabric covers may be utilized to cover portions of the frame surface which would otherwise be exposed and hard finished.

For example, a first set of upholstered covers 100 may be attached to frame 70, described in FIGS. 7, 7A, and 8, as illustrated in FIG. 9. Upholstery covers 100 may include arm covers 100a, 100b, seat back cover 100c, and front cover 100d. Arm covers 100a, 100b include arm pockets 104 and flaps 106 having hook and loop fasteners 108 thereon. As illustrated in FIG. 9, arm covers 100a, 100b are slid onto arm panels 72d, 72e of frame 70, such that arm panels 72d, 72e are received within arm pockets 104. Similarly, seat back cover 100c includes seat back pocket 110 and flaps 106 and is slid onto seat pack panel 72g of frame 70 such that seat back panel 72g is received within seat back pocket 110. Front cover 100d includes insert pocket 112 having insert 72k therein, which is draped over front panel 72f of frame 70 to hold front cover 100d in place.

The lower portions of arm covers 100a, 100b, seat back cover 100c, and front cover 100d each include flaps 106 having hook and loop fasteners 108 which overlap and fasten to one another to define skirt 114 around the lower portion of chair 98. Skirt 114 has a clean, stitched appearance which appears identical to the stitched skirt seen on conventional furniture. The lower portions of arm covers 100a, 10b, seat back cover 100c, as well as front cover 100d each further include a weighted beading 116 stitched therein to provide a decorative finish for skirt 114 and to maintain skirt 114 flat around the outer portion of chair 98. As illustrated in FIG. 9, storage compartment lid panel 72j is hingedly connected and may be lifted for selective access to storage compartment 118 within frame 70.

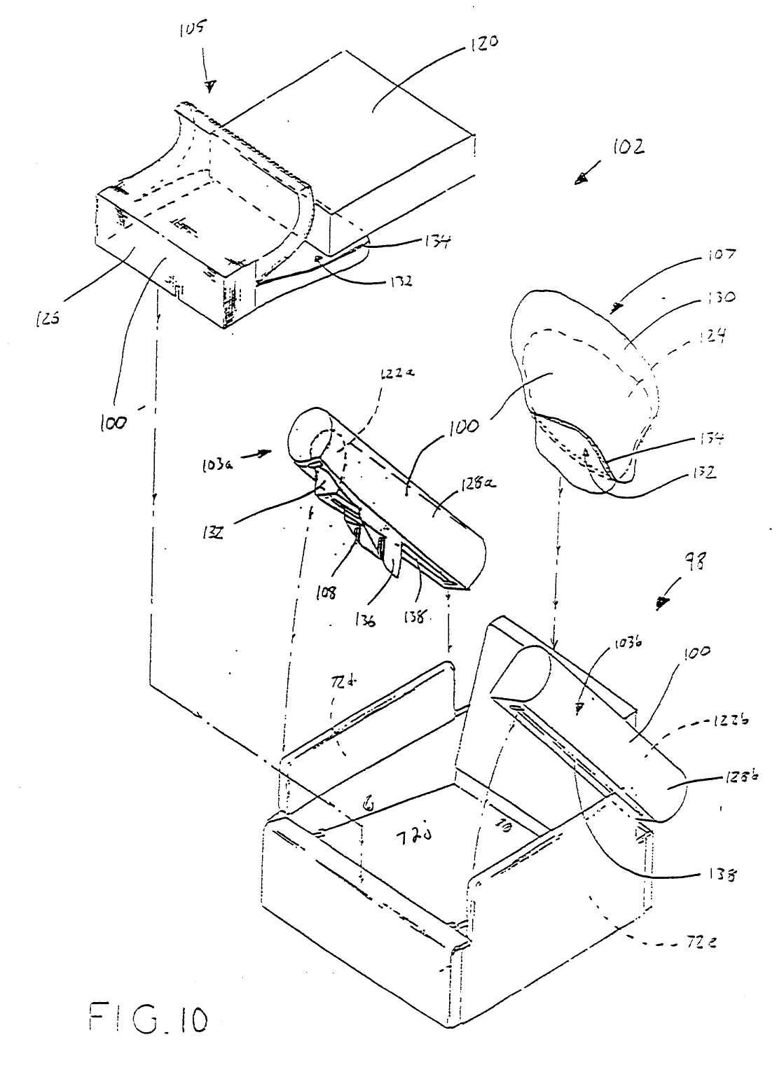

FIG. 10 illustrates the assembly of cushions 102 for chair 98. Seat padding 120, and arm pads 122a, 122b, are typically formed of foam elements, while seat back padding 124 typically comprises a pillow. Seat padding 120, arm pads 122a, 122b, and seat back padding 124 are covered by a second set of upholstery covers 100, including seat cover 126, arm covers 128a, 128b, and seat back cover 130 to form seat cushion 105, arm cushions 103a, 103b, and seat back cushion 107, respectively. As illustrated in FIG. 10, seat padding 120 is inserted within seat cover 126, which includes a large opening 132 to ease insertion of seat padding 120 therein. Seat cover 126 additionally includes fasteners 134 such as hook and loop fasteners or a zipper fastener to close seat cover 126 around seat padding 120 and thereby form completed seat cushion 105. Seat cushion 105 is then placed on storage compartment lid 72j to form a seat for chair 98. Similarly, seat back padding 124 is inserted into seat back cover 130 which also includes a large opening 132 and fasteners 134 to close seat back cover 130 around seat back padding 124. Seat back cushion 107 is then placed on seat cushion 105 adjacent seat back panel 72h of chair 98.

Arm pads 122a, 122b are inserted into arm covers 128a, 128b, which additionally include large opening 132. Flaps 136 of arm covers 128a, 128b are attached to one another by hook and loop fasteners 108 and then stuffed into envelope slits 138 of arm pads 122a, 122b to form arm cushions 103a, 103b. Arm cushions 103a, 103b are then mounted onto arm panels 72d, 72e such that arm panels are received within envelope slits 138 of arm cushions 103a, 103b.

FIG. 11 illustrates assembled chair 98, including seat cushion 102, seat back cushion 107, and arm cushions 103a, 103b disposed on frame 70, which is covered by seat back cover 100c, arm covers 100a (not shown), 100b, and front cover 100d. As illustrated in FIG. 11, one chair formed by the current invention is fully upholstered, such that no portion of frame 70 is visible. Optionally, decorative pillow 140 may be included with chair 98 corresponding to consumer choice. An advantage of the furniture of the current invention is that it may be disassembled for transportation or storage in a manner opposite to the manner of assembly described above.

As described above, FIG. 12 illustrates an advantageous method of packaging an article of furniture such as chair 98 for shipment. Frame member 72, as well as push-in connector elements 84 and fasteners 88 disposed within bag 142 are packaged in a first container 144. Seat padding 120, arm pads 122a, 122b, and seat back padding 124 are packaged in second container 146, while upholstery covers are packaged in a third container 148. In an alternative embodiment, upholstery covers 100 are packaged together with padding members 120, 122a, 122b, and 124 in second container 146. In one embodiment, a return package may be included with upholstery covers 100 to facilitate return thereof. It bears mention that padding members 120, 122a, 122b, and 124 may be formed of a compressible material so that these members may be compressed prior to insertion into second container 146. This will allow the size of second container 146 to be further diminished. In this manner, chair 98 may be packaged in two or three separate containers 144, 146, 148, each of which weighs less than 70 pounds, thereby allowing containers 144, 146, and 148 to be shipped for home delivery by a standard direct parcel delivery service, such as, e.g., FEDERAL EXPRESS GROUND or UNITED PARCEL SERVICE.

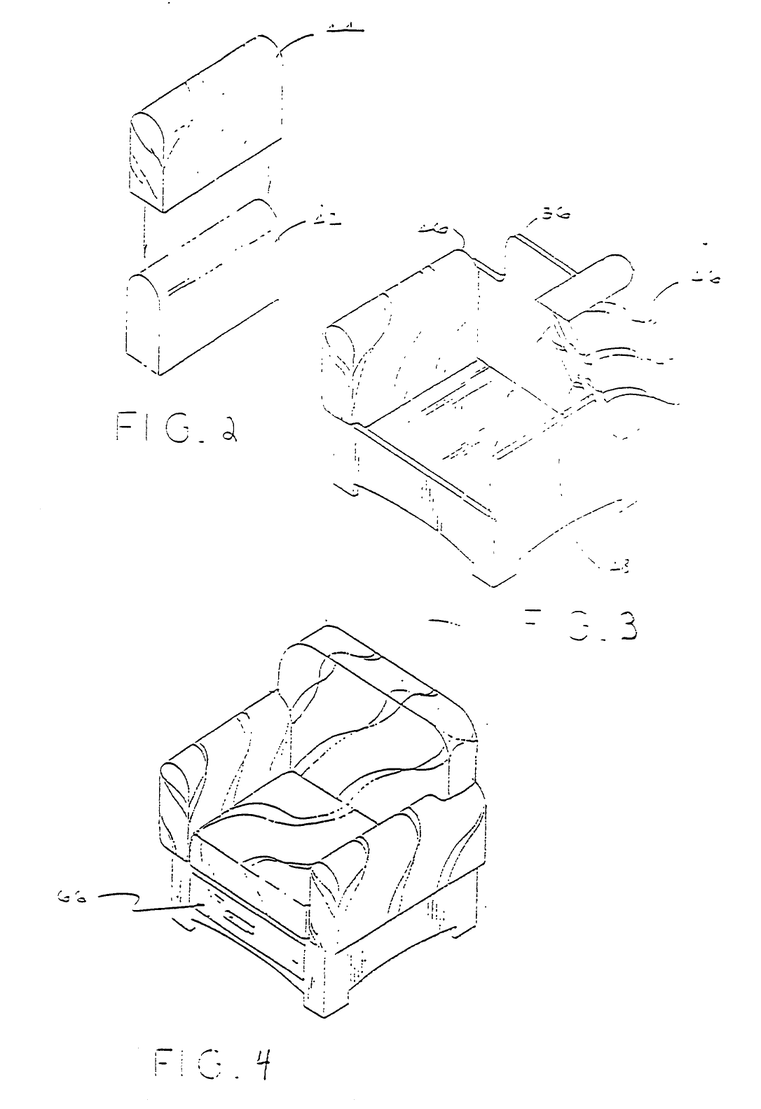

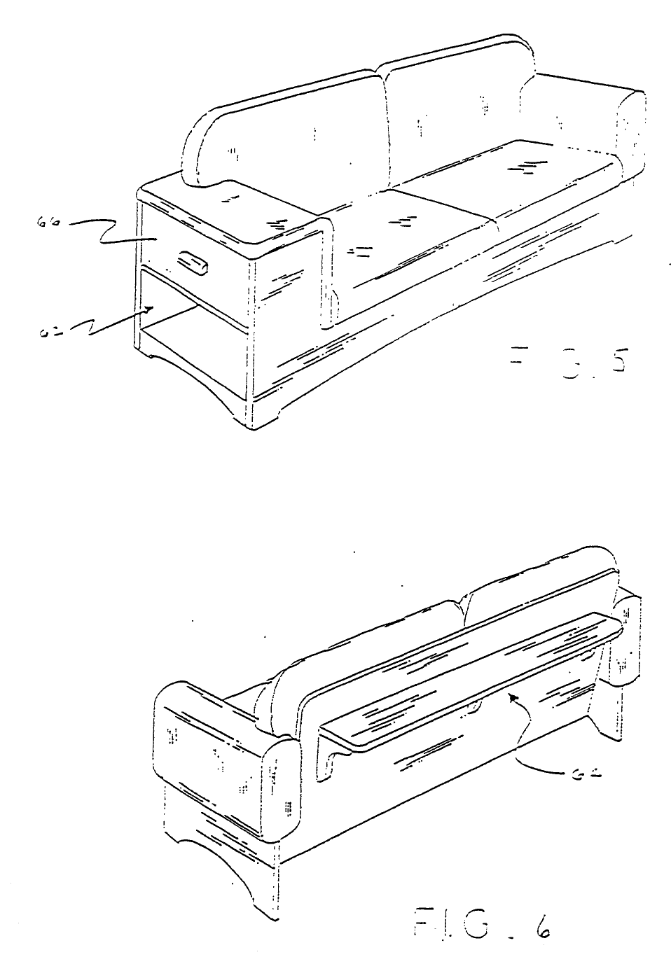

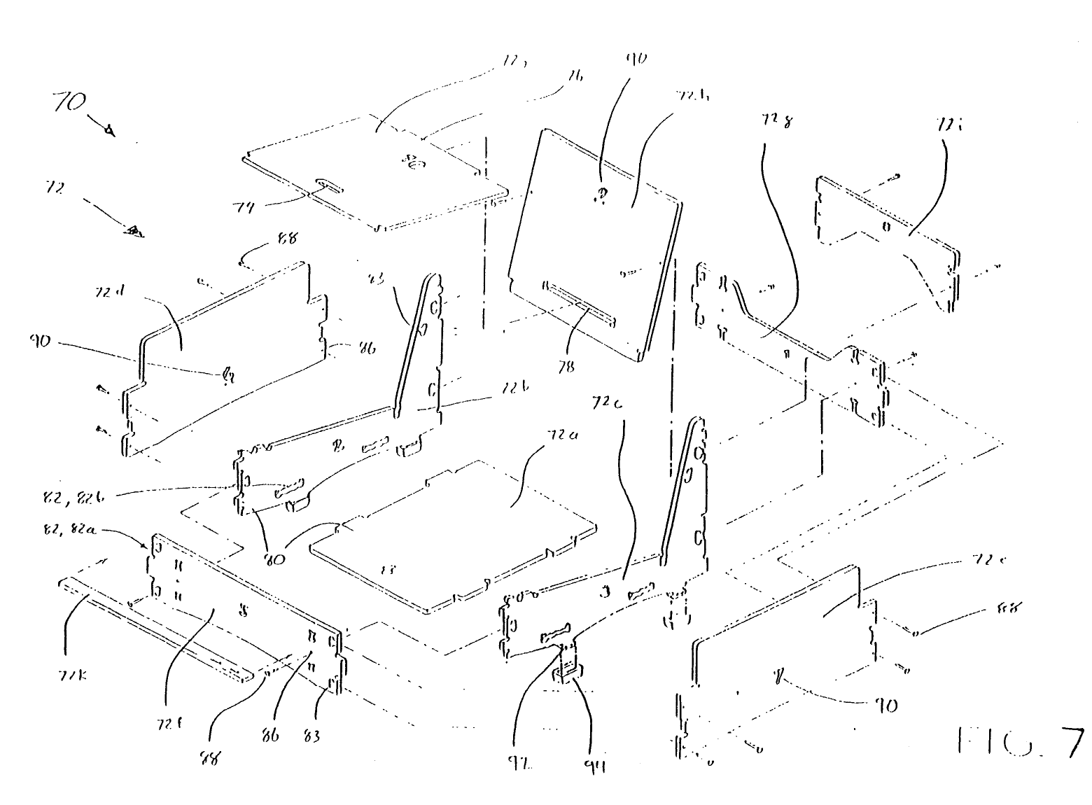

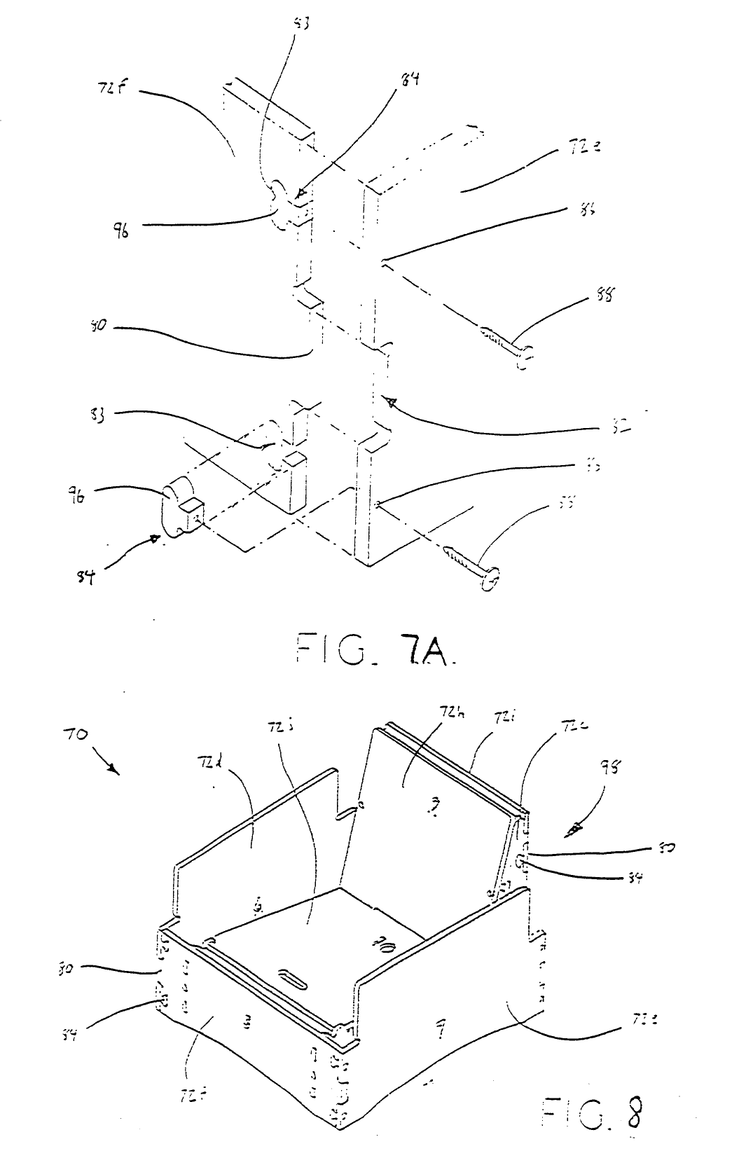

As illustrated in FIGS. 6-8, the article of fully upholstered furniture may take the form of, e.g., chairs, or sofas. Furthermore, the article of furniture may also incorporate features such as drawer 66, as illustrated in FIGS. 4 and 7, bookcase 62, as illustrated in FIG. 5, or shelf 64, as illustrated in FIG. 6. In such embodiments, the components necessary to provide these features are packaged as and/or with frame members and incorporated as the frame is assembled. The embodiments illustrated in FIGS. 7 and 8 provide particular examples of this aspect of the present invention and should not be construed as limiting its scope. Further embodiments incorporating features, such as, e.g., cup holders, magazine racks, television remote control holders, and the like, and locating them in or on various surfaces of the frame are contemplated within the scope of the present invention.

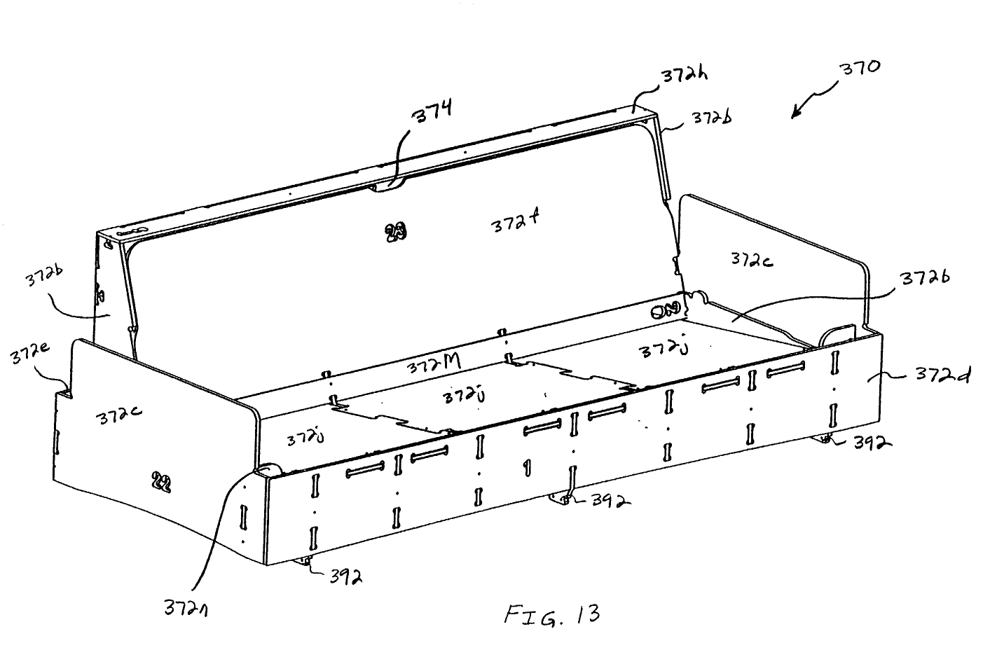

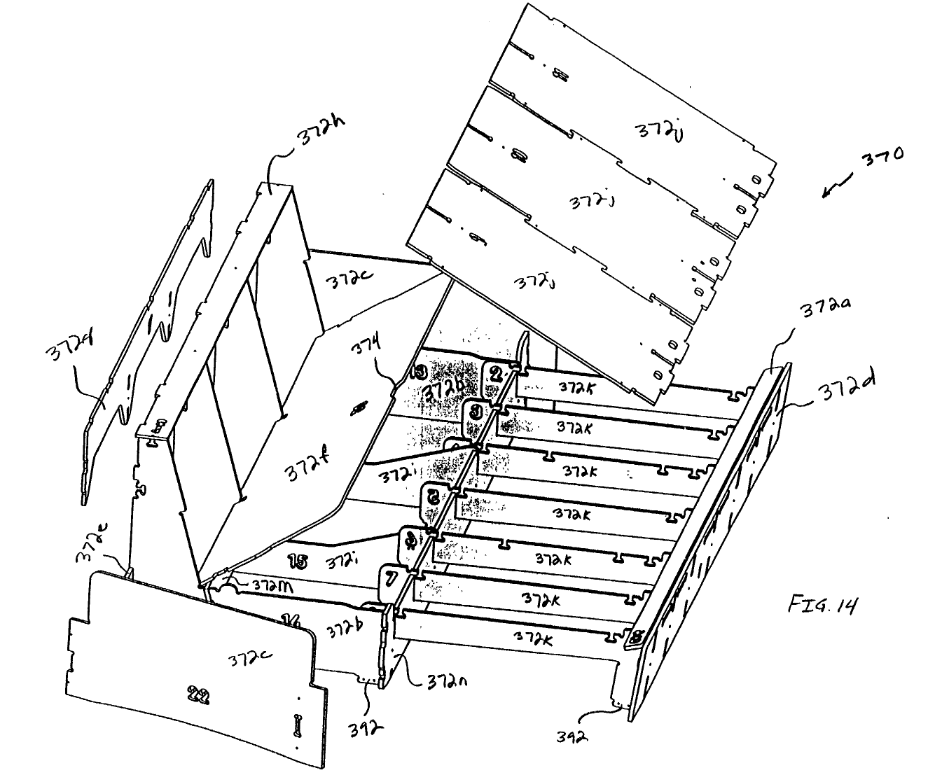

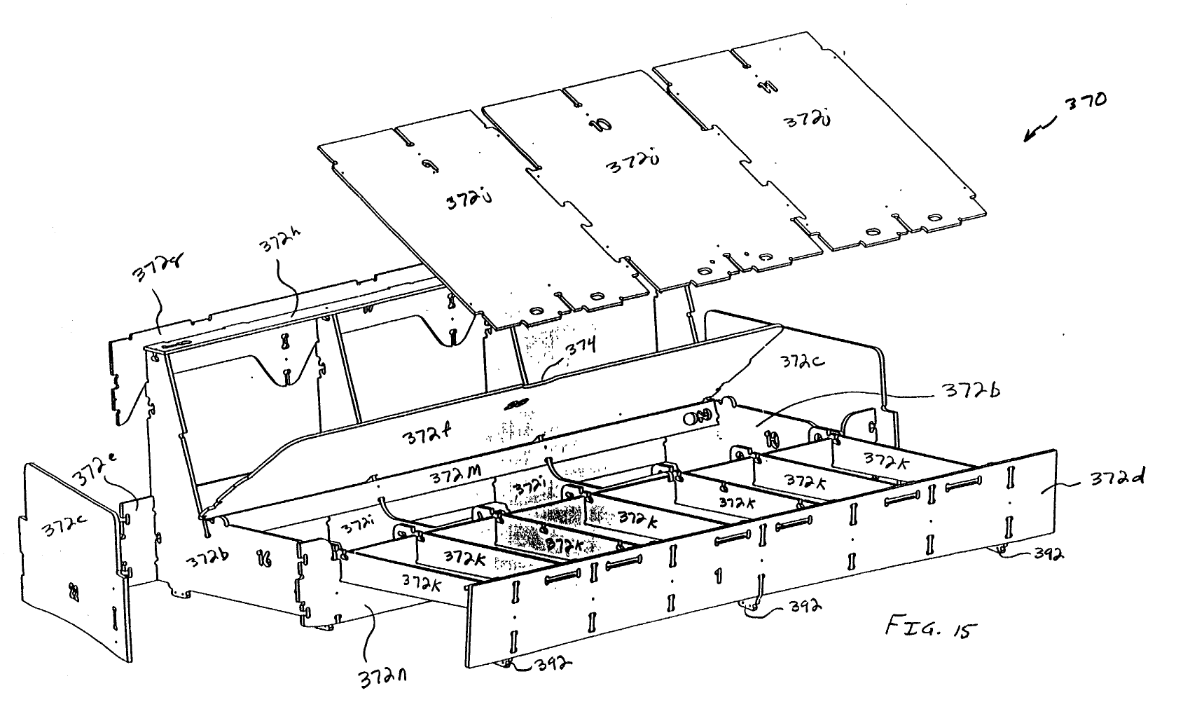

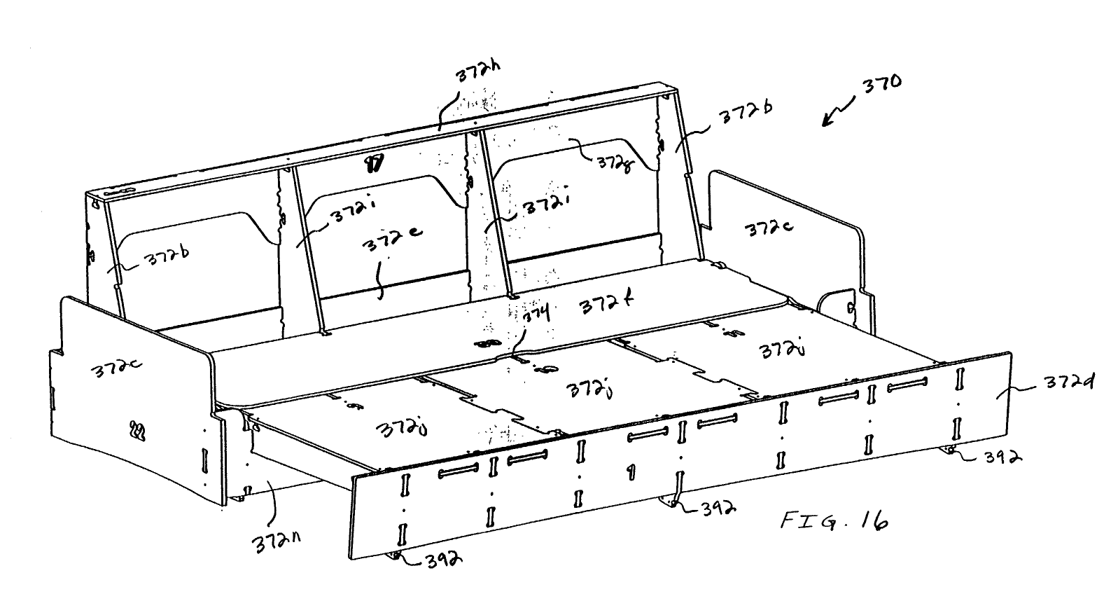

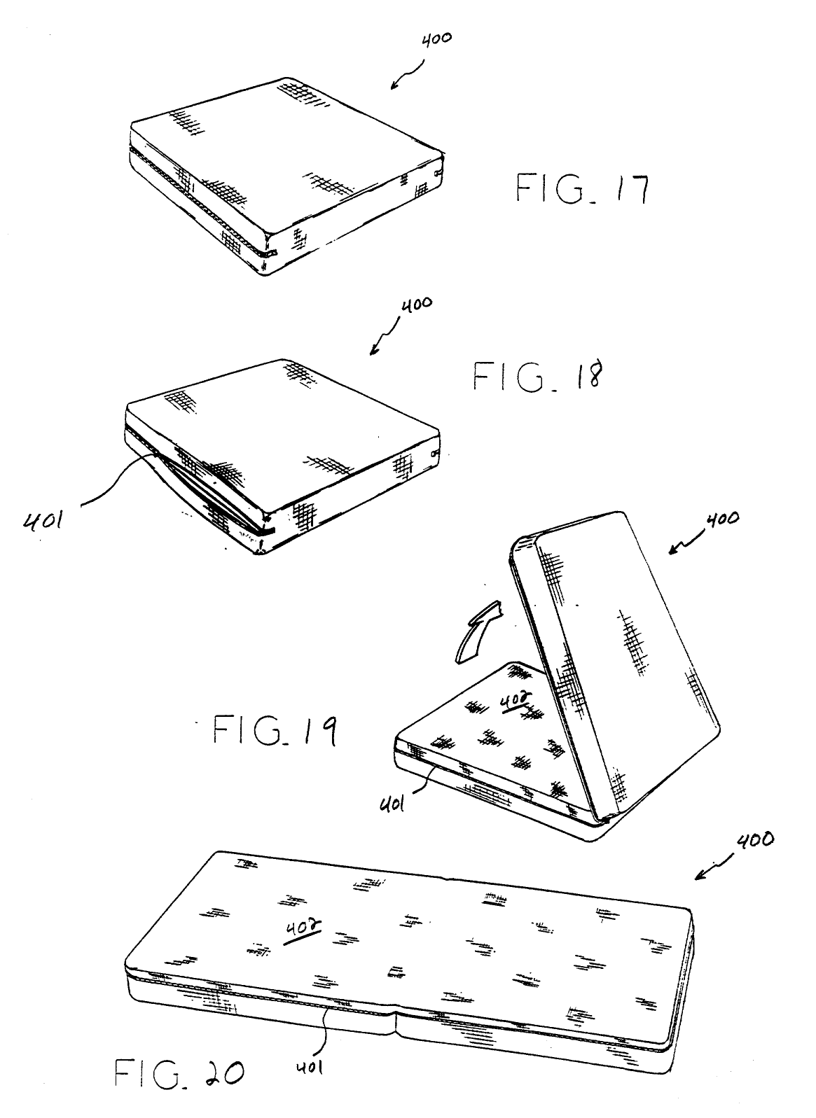

FIGS. 13 through 20 illustrate a sofa bed in accordance with the present invention. FIGS. 13 through 16 illustrate an embodiment of frame 370 including a plurality of individual frame members 372 which are assembled together to form frame 370. As described above, frame members 372 are planer sheets or panels, and may be made of medium density fiberboard (“MDF”). As illustrated in FIG. 14, frame members 372 generally include front panel 372d, seat support panels 372k, transition panel 372a, intermediate panel 372n, back panel 372e, interior side panels 372b, interior panels 372i, arm panels 372c, seat back support panel 372g, top panel 372h, seat panels 372j, seat back panel 372f, and seat back support panel 372m. Seat back panel 372f includes handle cutout 374 to facilitate movement thereof (described further hereinbelow). The individual frame members 372 forming sofa bed frame 370 are interconnected in the same manner as described above with respect to frame 70 illustrated in FIG. 7. For the sake of brevity, this material will not be repeated here.

Intermediate panel 372n includes a plurality of slots corresponding in number to seat support panels 372k. These slots allow forward movement of front panel 372d so that the configuration of frame 370 may be altered from the sofa configuration illustrated in FIG. 13 to the bed configuration illustrated in FIG. 16. To convert sofa bed frame 370 from its sofa bed configuration as illustrated in FIG. 13 to its bed configuration as illustrated in FIG. 16, front panel 372d is pulled forward so that seat panels 372j are pulled away from back panel 372e to form a first part of the bed surface. The bed surface is completed by rotating seat back panel 372f from its position illustrated in FIG. 13 to an intermediate position illustrated in FIG. 15, and finally to a generally horizontal position as illustrated in FIG. 16. Handle cutout 374 facilitates movement of seat back panel 372f in this fashion. FIGS. 14 and 15 provide partially exploded views to better illustrate frame members 372.

FIG. 13 illustrates sofa bed frame 370 positioned in a sofa configuration and resting on feet 392. Assembly of a sofa utilizing frame 370 is completed by attaching upholstery covers in largely the same fashion as described above with respect to chair 98. The upholstery covers are, of course, sized to fit frame 370. Otherwise the upholstery covers utilized with frame 370 differ only in the use of sofa bed cushion 400 illustrated in FIGS. 17 through 20. As with the seat cushion described above with respect to chair 98, sofa bed cushions 400 may be enclosed within various upholstery covers to accommodate various decor. Sofa bed cushion 400 is adapted to function both as a sofa cushion and as a bed mattress.

As illustrated in FIGS. 17 through 20, sofa bed cushion 400 includes zipper 401 positioned about the perimeter thereof. As illustrated in FIG. 17, zipper 401 is closed to place sofa bed cushion 400 in its sofa seat configuration. FIG. 18 illustrates the unzipping of zipper 401 so that sofa bed cushion 400 can be placed in its bed configuration as illustrated in FIG. 20. After zipper 401 is completely unzipped, sofa bed cushion 400 is unfolded (FIG. 19) to reveal bed surface 402. Sofa bed cushion 400 can then be placed atop seat back panel 372f and seat panels 372j to form a bed surface.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of selling fully upholstered furniture, comprising:
receiving a consumer order for a desired furniture type and upholstery cover style;
determining if said desired furniture type and upholstery cover is available;
gathering all the furniture components necessary to complete said order;
packaging all the furniture components into at least one shipping package that is within the size and weight limitations of a regular direct parcel delivery service; and
shipping, via said direct parcel delivery service, all the furniture components to said consumer.

2. The method of claim 1, wherein said step of packing said furniture components into at least one shipping package that is within the size and weight limitations of the direct parcel delivery service comprises the steps of:
providing an unassembled frame, the frame including a plurality of planer frame members;
packing the frame members in a first shipping package;
providing a padding element adapted to form a cushion for the article of furniture;
packaging the padding element in a second shipping package;
providing an upholstery cover adapted to attach to the frame; and
packaging the upholstery cover in said second shipping package.

3. The method of claim 1, wherein said step of packing said furniture components into at least one shipping package that is within the size and weight limitations of the direct parcel delivery service comprises the steps of:
providing an unassembled frame, the frame including a plurality of planar frame members;
packing the frame members in a first shipping package;
providing a padding element adapted to form a cushion for the article of furniture;
packaging the padding element in a second shipping package;
providing an upholstery cover adapted to attach to the frame; and
packaging the upholstery cover in a third shipping package.

4. The method of claim 3, wherein said step of providing a padding element adapted to form a cushion for the article of furniture comprises providing a plurality of padding elements adapted to form a plurality of cushioned members, including a seat cushion, a seat back cushion, and a pair of arm cushions.

5. The method of claim 3, wherein said frame members are made of medium density fiber board.

6. The method of claim 3, wherein each of the first, second, and third shipping packages have a weight after packaging of less than 70 pounds.

7. The method of claim 3, wherein each of the first, second, and third shipping packages have a weight-after-packaging of less than 150 pounds, a length of less than 270 centimeters, and a girth whereby the combined measurement of the length and the girth is less than 330 centimeters.

8. The method of claim 3, further comprising:
providing a push-in connector element and a fastener for connecting the frame members; and
packing the connector element and the fastener in the first shipping package along with the frame members.

9. The method of claim 1, further comprising:
assembling the furniture components to form a fully upholstered article of furniture.

10. The method of claim 9, wherein said assembling step comprises:
providing a disassembled frame, including a plurality of planar frame members having interlocking portions, recesses and apertures;
a plurality of push-in connector elements; and
a plurality of fasteners;
pushing the connector elements in the recesses;
connecting the interlocking portions of said frame members; and
securing the frame members by inserting the fasteners through the apertures and into the connector elements.

11. The method of claim 10, wherein said frame members are made of medium density fiber board.

12. The method of claim 10, further comprising:
applying an upholstery cover over the frame members, said upholstery cover including hook and loop fasteners.

13. The method of claim 12, further comprising:
providing a padding element and a second upholstery cover, said second upholstery cover including a relatively large opening adapted to receive the padding member, and a fastener for closing the opening;
inserting the padding member through the opening and into the upholstery cover;
fastening the fastener to close the upholstery cover to form a cushion for the article of furniture; and
placing the cushion on the article of furniture.

14. The method of claim 1, wherein said step of receiving a consumer order for a desired furniture type and upholstery cover style comprises:
receiving an electronic message over a computer network, said electronic message including the consumer order.

15. The method of claim 14, wherein said step of receiving an electronic message over a computer network comprises:
querying a server having stored therein a database of furniture types and upholstery cover styles currently available for shipping;
said server communicating via said network the furniture types available.

16. The method of claim 1, wherein said step of receiving a consumer order for a desired furniture type and upholstery cover style comprises:
supplying a telephone bank dedicated to receiving consumer orders; and
communicatively linking said telephone bank to a server having stored therein a database of furniture types and upholstery cover styles currently available for shipping.

17. In computer system, a method of receiving consumer orders for fully upholstered furniture and delivering said orders to consumers via direct parcel delivery, said method comprising the steps of:
providing an interface on a computer for entering a consumer order for a desired furniture type and upholstery cover style;
determining if said desired furniture type and upholstery cover style is available;
gathering all the furniture components necessary to complete said order;
packing all the furniture components into at least one shipping package that is within the size and weight limitations of a regular direct parcel delivery service; and
shipping, via said direct parcel delivery service, all the furniture components to said consumer.

18. The method of claim 17, wherein said step of providing an interface on a computer for entering a consumer order for a desired furniture type and upholstery cover style comprises:
providing a server having stored therein a data base of furniture types and upholstery cover styles currently available for shipping;
communicatively linking said server to a network; and
allowing consumer access to said server via said network.

19. The method of claim 17 wherein said step of packaging said furniture components so as to be within the size and weight limitations of a direct parcel delivery service comprises the steps of:
providing an unassembled frame, the frame including a plurality of planar frame members;
packaging the frame members in a first container;
providing a padding element adapted to form a cushion for the article of furniture;
packaging the padding element in a second container;
providing an upholstery cover adapted to attach to the frame; and
packaging the upholstery cover in a third container.

20. The method of claim 19, wherein each of the first, second, and third containers have a weight after packaging of less than seventy pounds.

21. A system for allowing consumers to order over a computer network fully upholstered furniture for direct parcel delivery to the consumer, said system comprising:
a server coupled to the computer network, said server storing information relating to availability of furniture types and upholstery covers styles; and
a customer interface operated by said server including a query system for allowing a user to submit an inquiry to said server relating to a desired furniture type and upholstery cover style, said customer interface further including an ordering system for allowing said user of said customer computer to submit an order for a desired furniture type and upholstery cover style for direct parcel delivery to said user;
wherein said server includes a plurality of instructions for enabling said server to receive said inquiry from said customer computer, determine if said desired furniture type and upholstery cover style is available, and provide an output including identifying information relating to the furniture components necessary to complete said order;
wherein said furniture components are packaged into at least one shipping package that is within the size and weight limitations of a direct parcel delivery service.

22. A method of selling fully upholstered furniture, comprising:
providing an unassembled frame, the frame including a plurality of planer frame members;
packing the frame members in a first shipping package that is within the size and weight limitations of a regular direct parcel delivery service;
providing a padding element adapted to form a cushion for the article of furniture;
packaging the padding element in a second shipping package that is within the size and weight limitations of a regular direct parcel delivery service;
providing an upholstery cover adapted to attach to the frame;
packaging the upholstery cover in said second shipping package;
providing a return package sized to accommodate the upholstery cover;
packaging the return package in said second shipping package; and
shipping, via said direct parcel delivery service, said furniture components to said consumer.

23. The method of claim 22, further comprising the steps of:
receiving returned upholstery covers;
receiving a request for replacement upholstery covers;
packaging said replacement upholstery covers into at least one shipping package that is within the size and weight limitations of a regular direct parcel delivery service; and
shipping, via said direct parcel delivery service the replacement upholstery cover to said consumer.
